(19) United States
(12) Patent Application Publication
(10) Pub. No.: US 2008/0037728 A1
(43) Pub. Date: Feb. 14, 2008

(54) Method Of Monitoring A Message Stream Transmitted And/Or Received By An Internet Access Provider Customer Within A Telecommunication Network

(75) Inventors: Quentin Loudier, Pleumeur Bodou (FR); Bertrand Mathieu, Lannion (FR); Yvon Gourhant, Lannion (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM SA, Paris (FR)

(21) Appl. No.: 11/576,418

(22) PCT Filed: Aug. 9, 2005
(86) PCT No.: PCT/FR05/02062

§ 371 Date: Aug. 8, 2007

(30) Foreign Application Priority Data
Sep. 10, 2004 (FR) 0409606

(51) Int. Cl. H04M 11/00; H04M 1/65

(52) U.S. Cl. 379/88.17; 379/88.19; 379/88.22

(57) ABSTRACT

A method of monitoring electronic mails transmitted by an Internet access provider customer to a destination message server and/or received by the customer from a message server within a telecommunication network. The method includes the real-time inspection of electronic mails transmitted between the customer and the destination message server and received between the customer and the message server.

The present invention relates to a method of monitoring a message stream transmitted and/or received by a customer of an Internet access provider within a telecommunication network. The method according to the invention aims in particular to detect the viruses and spams contained in such message streams.

A virus is a small computer program capable of infecting a computer, for example by modifying one of its computer programs. The viruses are often transmitted via electronic mail. A spam is an electronic mail transmitted within a message stream, intentionally or not, in large numbers for the attention of recipients who have not solicited them. The methods used to transmit spams are becoming more and more powerful. Among these methods, those that consist in transmitting by electronic mail a virus or a worm, which, once routed to the terminal of the recipient customer, installs what is called a back door, are known. Through this back door, spams are transferred on command to electronic addresses, for example included in the email address book of this recipient customer or known to the virus otherwise.

The phenomenon of the intensive sending of viruses and spams is increasing, so legal solutions have been adopted to combat them and the transmitters of viruses and spams are also increasingly often the subject of legal pursuit. However, this type of solution does not truly resolve the problem of the sending of spam type electronic mail, particularly because these spams are often sent by customers who do not known that back doors have been installed on their terminals.

Furthermore, the protocols used to send electronic mail, such as, for example, the SMTP protocol (Simple Mail Transfer Protocol) or the ESMTP protocol (Extended Simple Mail Transfer Protocol), do not perform any check on the electronic mail transmitted. The transmission of spams is therefore not currently controlled on transmission.

Finally, the SMTP protocol allows the information needed to send electronic mail to be modified, so it is often difficult to combat these illicit transmittals because it is difficult to determine their real author, the transmitter of the electronic mail normally hijacking the identity of other customers.

Software solutions have also been developed. One first software solution is installed on the messaging servers. This software solution is designed to inspect the electronic mail after its transmission and before its reception by its recipient.

A second software solution installed on the customer terminals is designed to inspect the electronic mail the moment it is received by the terminals. These solutions do not, however, prevent the viruses and spams from using the communication pathways established between the transmitter and the SMTP server and thus of consuming significant resources of the Internet access provider used.

Furthermore, these solutions are not totally effective in distinguishing electronic mail since they do not allow the customers transmitting or receiving this electronic mail between themselves to be grouped into populations of similar behavior regarding spams or viruses. The Internet access providers are therefore coming up against difficulties in applying consistent and effective processes to the infected electronic mail.

Furthermore, the existing software solutions do not always allow viruses or spams to be detected on receiving electronic mail, for example when the messaging provider chosen by the customer is independent of the Internet access provider chosen by the customer. In practice, when an electronic mail is received by the messaging provider, the messaging platform of the Internet access provider does not systematically know this. Similarly, the existing software solutions do not allow viruses or spams to be detected on transmission of electronic mail, for example when the customer has his own messaging server. In practice, when an electronic mail is transmitted from the customer to a recipient, the electronic mail does not systematically pass through the Internet access provider, who therefore does not know about it.

The aim of the invention is therefore to propose a method of monitoring a message stream and of detecting viruses and spams that does not have the drawbacks of the solutions cited previously and tries to overcome the drawbacks inherent in the messaging protocols used.

To this end, the present invention relates to a method of monitoring a message stream transmitted by a customer of an Internet access provider to a recipient messaging server and/or received by said customer from his messaging server within a telecommunication network. According to the invention, the method consists in inspecting in real time said message streams between said customer and the recipient messaging server in transmit mode and between the customer and his messaging server in receive mode.

According to one advantageous embodiment of the invention, the method comprises:
a step for determining the category to which said customer belongs;
a step for analyzing a packet of said message stream in order to reveal virus and spam indices;
an interrogation step provided to determine, using the indices revealed in the analysis step, whether the analyzed packet contains at least one virus or belongs to a spam type message stream;
a step for processing the message stream according to the result of said interrogation step and the category of said customer.

Advantageously, prior to the determination step, the method comprises a customer identification step.

According to one particular embodiment of the invention, the interrogation steps are followed by a step for modifying the profile of the customer.

According to another particular embodiment of the invention, the method comprises a step for comparing the profile with a predetermined threshold provided to allow a modification of the category of the customer when the profile of said customer exceeds this predetermined threshold, and vice-versa.

According to another particular embodiment of the invention, the method comprises a step for making data available to said Internet access provider after the analysis, processing and profile modification steps have been executed.

According to another particular embodiment of the invention, the method comprises a step for notifying said Internet access provider after each virus and/or spam detection.

According to one original embodiment of the invention, the method consists in transmitting said message stream even if a virus or a spam has been detected, when the category of the customer requires it.

According to another original embodiment of the invention, the method consists in stopping said message stream when the category of the customer requires it, without executing the analysis step.

According to another original embodiment of the invention, the method consists in transmitting said message stream when the category of the customer requires it, without executing the analysis step.

According to another original embodiment of the invention, the method consists in monitoring electronic mail contained in said message streams.

The invention also relates to a system of monitoring a message stream transmitted by a customer of an Internet access provider to a recipient messaging server and/or received by said customer from his messaging server within a telecommunication network, characterized in that it comprises means for inspecting in real time said message streams between said customer and the recipient messaging server in transmit mode and between the customer and his messaging server in receive mode.

According to one advantageous embodiment of the invention, the system comprises:
means of determining the category to which said customer belongs;
means of analyzing a packet of said message stream provided to reveal virus and spam indices;
interrogation means provided to determine, using the indices revealed in the analysis step, whether the analyzed packet contains at least one virus or belongs to a spam type message stream;
means of processing the message stream according to the result of said interrogation step and the category of said customer.

Advantageously, the system comprises customer identification means.

According to one particular embodiment of the invention, the system comprises means of modifying the profile of the customer.

According to another particular embodiment of the invention, the system comprises means of comparing the profile with a predetermined threshold provided to allow a modification of the category of the customer when the profile of said customer exceeds this predetermined threshold, and vice-versa.

According to another particular embodiment of the invention, the system comprises means of making data available to said Internet access provider concerning virus and/or spam detections.

According to another particular embodiment of the invention, the system comprises means of notifying said Internet access provider of virus and/or spam detections.

According to an original embodiment of the invention, the system comprises means for transmitting said message stream even if a virus or a spam has been detected, when the category of the customer requires it.

The invention also relates to a probe for monitoring message streams transmitted by a customer to a recipient messaging server and/or received by said customer from his messaging server within a telecommunication network. According to the invention, the probe comprises means for implementing certain steps of the method described above.

According to one advantageous embodiment of the invention, the probe comprises means of determining a customer category, means of modifying the customer profile, means of notifying the Internet access provider of the customer and means of processing the message stream.

The characteristics of the invention mentioned above, and others, will become more clearly apparent from reading the following description of one exemplary embodiment, said description being given in relation to the appended drawings, in which:

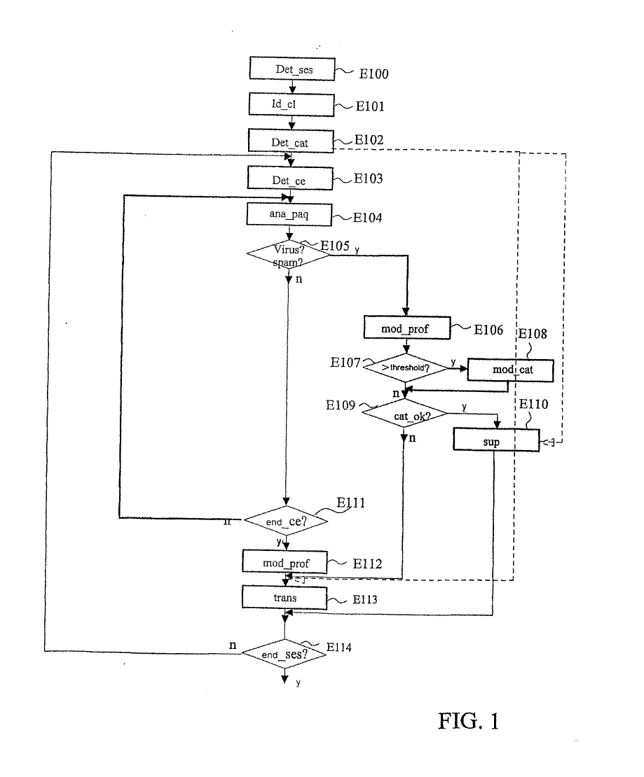

FIG. 1 is an algorithm of the method of monitoring message streams according to the invention;

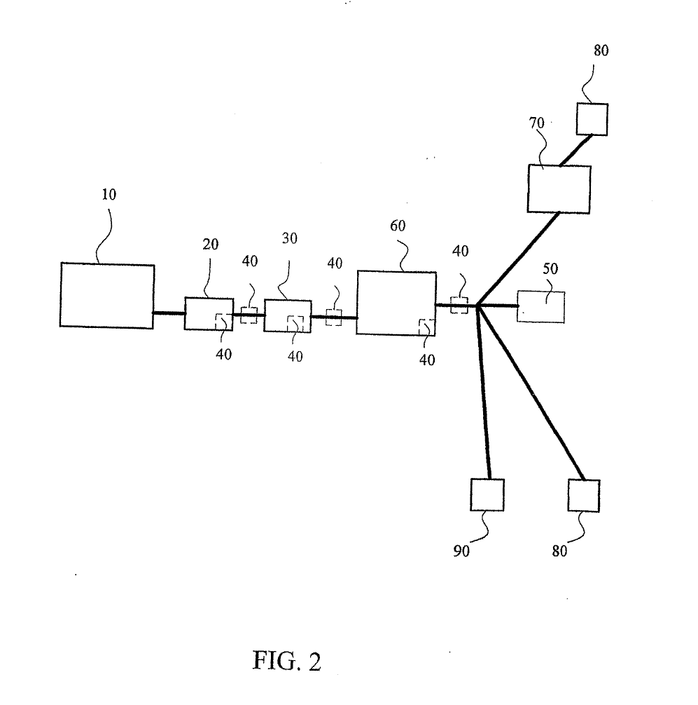

FIG. 2 is a diagrammatic representation of a first embodiment of the monitoring system according to the invention; and

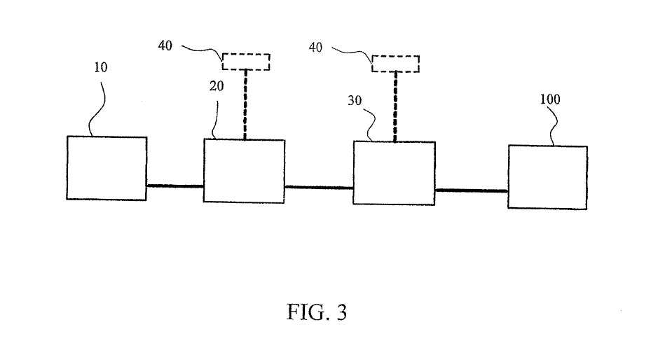

FIG. 3 is a diagrammatic representation of a second embodiment of the monitoring system according to the invention.

The method according to the invention is designed to limit the number of message streams of spam type or including viruses circulating in a telecommunication network. The method also enables a predetermined Internet access provider to be informed of the spams and viruses transmitted and/or received by its customers.

The method according to the invention applies to any messaging protocol designed to implement a TCP (Transmission Control Protocol) session. According to the invention, the protocols used to transmit message streams are preferably the SMTP protocol and the ESMTP protocol, and the protocol used to receive message streams is the POP3 protocol (Post Office Protocol) or the IMAP4 protocol (Internet Message Access Protocol).

It will be noted that, hereinafter in the present explanation, the term “message stream” will be used rather than “electronic mail”, because the information transmitted and received by a customer of an Internet access provider is not limited to just electronic mail. In practice, an electronic mail comprises a header and, in a part called the body of the message, the information proper that the customer of the access provider wants to send. This electronic mail is accompanied within a message stream with protocol commands making it possible, for example, to specify the source and the destination of the electronic mail, and protocol responses making it possible, for example, to specify whether a protocol command is denied or accepted and the associated reason.

According to the inventive method, message streams are transmitted at the initiative of the customer who sets up a TCP session, either toward a relay SMTP server which can be that of his Internet access provider which serves as a relay, or toward the SMTP server of the recipient of the message stream. Similarly, a message stream is received at the initiative of the receiver who sets up a TCP session toward the POP or IMAP server of his messaging provider.

The inventive method acts in real time each time a TCP session is initialized at the initiative of the receiver or of the transmitter who can be either a customer of the Internet access provider or a relay SMTP server.

The method is described in relation to FIG. 1.

During a first detection step E100, the session that has just been initialized is detected. Following this step, an identification step E101 is implemented. During this identification step, the customer originating the detected session is recognized.

During a determination step E102, the category to which the customer previously identified belongs is determined. This category is predefined by the Internet access provider of the customer. Such a category can, for example, be entitled “VIP” or “black list”, the “VIP” category corresponding to customers judged to be important and the “black list” category corresponding to customers judged to be a nuisance from the virus and spam point of view. This category has consequences on the progress of the steps that follow and in particular the analysis and processing steps that will be described below.

It will be noted that the inventive method provides, for certain customer categories, such as, for example, the “VIP” category customers, for the message stream detected to be transferred directly without searching for viruses and spams and for certain other categories of customers, such as, for example, the “black list” category customers, for the message stream detected to be stopped immediately without searching for viruses and spams (see broken line arrows).

For each known customer of an Internet access provider, customer profiles are also provided. These customer profiles define a behavior of the customer in relation to the viruses and spams. For example, the customer may be a regular spam transmitter, whether such transmission is intentional or not. The customer profile can be determined at the same time as the category to which the customer belongs. This profile is updated on each session and is stored for use in subsequent sessions and consulted by the Internet access provider of the customer to whom this profile corresponds. The information contained in these profiles includes, for example, the presence or absence of virus or spam-revealing elements in the message streams inspected, the number of these elements detected, the names of the viruses associated with the detected elements, the number of electronic mails transmitted containing such elements, etc.

During a second detection step E103, the message stream transmitted in the current session is detected.

During an analysis step E104, the presence of virus- and spam-revealing elements is looked for. For this, packets positioned one after the other and thus forming the detected message stream, are analyzed one by one using multiple analysis techniques. The choice of analysis techniques used is determined by the category of the customer originating the message stream being analyzed.

Such analysis methods can, for example, consist in analyzing the header fields of an electronic mail, analyzing significant key words of a spam-type electronic mail, analyzing character strings or strings of bytes corresponding to a virus, analyzing the format of an attachment to an electronic mail, etc.

Thus, one technique used in virus analysis is to search for virus signatures. Spam analysis is different. It consists in searching for spam indices. Depending on the index being searched for, the presence or the repetition of this index is searched for and helps to determine that the message stream in which it is found is a spam. Such spam indices can, for example, be malformed character strings, or character strings including a mix of digits and letters, a message stream addressed to more than a hundred recipients, etc.

During an interrogation step E105, the report of the analyses carried out on the packet of the message stream is produced. This report consists in defining if, according to these analyses, the packet being analyzed contains a virus or belongs to a spam-type message stream. If the result of the interrogation step E105 makes it possible to state that the packet being analyzed does not contain virus or does not belong to a spam-type message stream, then the next step is the step E111.

During this step E111, the analyzed packet is checked to see if it is an end-of-message-stream packet. If the analyzed packet is not the last of the message stream, the next step is once again the packet analysis step E104. If the analyzed packet terminates the message stream, then the step E111 is followed by a profile modification step E112. During this profile modification step E112, the profile of the customer is modified so as to reveal the absence of virus or spams in the transmitted message stream. This modification consists, for example, in inserting information representative of the absence of virus or even in modifying statistics.

During a transmission step E113, the message stream is then transmitted to its recipient without its content being modified.

During a consecutive interrogation step E114, a check is made to see if the current session is finished. If the current session is not finished, then the algorithm resumes at the message stream detection step E103. Otherwise, the method is finished.

However, if a virus is revealed in the analyzed packet or if the message stream from which the packet has been analyzed is considered as a spam, then the next step is a profile modification step E106.

During the profile modification step E106, the profile of the customer transmitting the message stream is modified so as to show the presence of the revealed virus or spam.

During a comparison step E107, the profile of the customer is compared with a threshold. This threshold is defined by the Internet access provider and corresponds to a profile beyond which the category of the customer is modified. Thus, if the profile newly updated during the step E106 is a value that exceeds a predefined value representing this threshold, the category of the customer is modified during a step E108.

During a decision step E109, the processing of the message stream is determined. This step is carried out following one of the steps E107 or E108.

Thus, if the category of the customer is such that no transfer is possible, the message stream is stopped (step E110). Otherwise, if the category of the customer allows it, a transfer of the message stream is performed (step E113). This transfer can be performed in a conventional way, or, for example, with the transmission speed slowed down, or even with the message stream modified for a subsequent processing.

Following this step E113, the data obtained from the analysis of the packets of the message stream, the profile modifications and the processes performed on the message stream are made available to the access provider of the customer. Furthermore, notification can be given to the Internet access provider of the customer transmitting the message stream of the presence of virus in the message stream analyzed by the inventive method. A warning electronic mail can also be transmitted to the customer in order to warn him that his message stream is infected by a virus or a spam and, for example, propose solutions to him to decontaminate his system.

The next step is then the step E114 during which a check is carried out to see if the current session is finished. If the current session is not finished, then the algorithm resumes at the message stream detection step E103. Otherwise, the method is finished.

The method described previously can be implemented within a system, two embodiments of which are described below in relation to FIGS. 2 and 3 respectively.

A first embodiment of the system according to the invention is represented in FIG. 2. In this FIG. 2, the system is implemented for emitted message streams. It will, however, be understood that such a system can also be implemented for received message stream.

In this embodiment, the customers 10 send and receive message streams via Internet access providers 70 and messaging providers 80 belonging to the Internet access providers or separate from the latter.

A modem 20, a DSLAM network distribution frame (Digital Subscriber Line Access Multiplexer) 30 operating using an ATM (Asynchronous Transmission Mode) protocol and a BAS 60 (Broadband Access Server) router, link each customer 10 to his messaging provider 80 directly or via an Internet access provider 70. The customer 10 can also be directly linked to the messaging provider 90 of the recipient of the message stream.

A two-level monitoring architecture is arranged between the customers 10 and their respective Internet access providers 70 or their messaging providers 80 or the messaging providers 90 of the recipients.

A first architecture level is illustrated by the first level devices 40. Each of the first level architecture devices 40 is preferably a probe used as a means for detecting the parameters of the message stream detected and in particular for determining the category of the customer transmitting the detected message stream.

The first level device 40 can equally be placed in the modem 20, between the modem 20 and the DSLAM network distribution frame 30, in the DSLAM network distribution frame 30, at the output of the DSLAM network distribution frame 30, in the BAS router 60 or at the output of the BAS router 60.

The second architecture level is illustrated by a second level device 50. This second level device 50 is a processing means provided to perform the steps of the method apart from the steps already performed by the first level device 40. This second level device 50 is linked to the first level device 40.

In the example represented, each message stream transmitted by a customer terminal 10 is routed to a first architecture level device 40 which determines the category of the customer transmitting the detected message stream and if this category allows it to transfer the message stream to the second architecture level device 50. Otherwise, the first architecture level device 40 directly transfers the message stream.

It will be noted that the first architecture level device 40 could perform other steps of the method and in particular the analysis step.

A second embodiment of the inventive system is described in relation to FIG. 3. The system that is represented is installed on transmission and reception of the SMTP message stream traffic.

In this embodiment, a customer messaging server 10 is linked to a recipient messaging server 100 via a customer router CE (Client Edge) 20 and a PE (Provider Edge) router 30 of the Internet access provider of the customer.

According to the invention, a processing device 40 is linked to the PE router 30 of the Internet access provider of the customer. This processing device 40 is provided to perform all the steps of the inventive method.

The PE router 30 redirects all the message streams to the processing device 40 which executes the algorithm of FIG. 1. While the algorithm is being executed, the processing device 40 redirects the analyzed packets to the recipient messaging server 100. It will be noted that the processing device 40 could be linked to the CE customer router 20 instead of the PE router 30.

In this second embodiment, only the SMTP traffic is diverted to the single processing device 40. Advantageously, this processing device 40 is therefore a single device not needed to have significant power.

1-21. (canceled)

22. A method of monitoring a message stream transmitted by a customer of an Internet access provider to a recipient messaging server and/or received by the customer from a messaging server within a telecommunication network, the method comprising:
inspecting in real time the message streams between the customer and the recipient messaging server in a transmit mode and between the customer and the messaging server in a receive mode.

23. The method as claimed in claim 22, comprising:
determining a category to which the customer belongs;
analyzing a packet of the message stream to reveal virus and spam indices;
interrogating to determine, using the indices revealed in the analyzing, whether the analyzed packet contains at least one virus or belongs to a spam type message stream;
processing the message stream according to the result of the interrogating and the category of the customer.

24. The method as claimed in claim 22, wherein, prior to the determining, the method comprises identifying the customer.

25. The method as claimed in claim 22, wherein the interrogating is followed by modifying a profile of the customer.

26. The method as claimed in claim 25, further comprising comparing the profile with a predetermined threshold provided to allow a modification of the category of the customer when the profile of the customer exceeds the predetermined threshold, and vice-versa.

27. The method as claimed in claim 25, further comprising making data available to the Internet access provider after the analyzing, processing, and modifying have been executed.

28. The method as claimed in claim 22, further comprising notifying the Internet access provider after each virus and/or spam detection.

29. The method as claimed in claim 22, further comprising transmitting the message stream even if a virus or a spam has been detected, when the category of the customer requires it.

30. The method as claimed in claim 22, further comprising stopping the message stream when the category of the customer requires it, without executing the analyzing.

31. The method as claimed in claim 22, further comprising transferring the message stream when the category of the customer requires it, without executing the analyzing.

32. The method as claimed in claim 22, further comprising monitoring electronic mail contained in the message streams.

33. A system of monitoring a message stream transmitted by a customer of an Internet access provider to a recipient messaging server and/or received by the customer from a messaging server within a telecommunication network, comprising:
means for inspecting in real time the message streams between the customer and the recipient messaging server in a transmit mode and between the customer and the messaging server in a receive mode.

34. The system as claimed in claim 33, further comprising:
means for determining a category to which the customer belongs;
means for analyzing a packet of the message stream provided to reveal virus and spam indices;
means for interrogating to determine, using the indices revealed by the means for analyzing, whether the analyzed packet contains at least one virus or belongs to a spam type message stream;
means for processing the message stream according to the result of the means for interrogating and the category of the customer.

35. The system as claimed in claim 33, further comprising means for identifying the customer.

36. The system as claimed in claim 33, further comprising means for modifying the profile of the customer.

37. The system as claimed in claim 36, further comprising means for comparing the profile with a predetermined threshold provided to allow a modification of the category of the customer when the profile of the customer exceeds the predetermined threshold, and vice-versa.

38. The system as claimed in claim 33, further comprises means for making data available to the Internet access provider.

39. The system as claimed in claim 33, further comprising means for notifying the Internet access provider after each virus and/or spam detection.

40. The system as claimed in claim 33, further comprising means for transmitting the message stream even if a virus or a spam has been detected, when the category of the customer requires it.

41. A probe for monitoring message streams transmitted by a customer to a recipient messaging server and/or received by the customer from a messaging server within a telecommunication network, comprising:
means for implementing the method as claimed in claim 22.

42. The probe as claimed in claim 40, comprising:
means for determining a customer category;
means for modifying the customer profile;
means for making data available to the Internet access provider of the customer; and means for processing the message stream.
